(19) United States
(12) Patent Application Publication
(10) Pub. No.: US 2012/0144722 A1
(43) Pub. Date: Jun. 14, 2012

(54) CRUSTACEAN TRAP WITH DEGRADABLE CULL RING PANEL

(75) Inventors: Kirk J. Havens, Plainview, VA (US); Donna Marie Bilkovic, Gloucester Point, VA (US); David M. Stanhope, Hayes, VA (US); Kory T. Angstadt, Gloucester, VA (US)

(73) Assignee: COLLEGE OF WILLIAM AND MARY, Williamsburg, VA (US)

(21) Appl. No.: 13/403,083

(22) Filed: Feb. 23, 2012

Related U.S. Application Data
(63) Continuation-in-part of application No. 12/714,370, filed on Feb. 26, 2010.
Application No. 12/714,370 is a continuation-in-part of application No. 12/394,917, filed on Feb. 27, 2009, now abandoned.
(60) Provisional application No. 61/032,266, filed on Feb. 28, 2008.

(51) Int. Cl. A01K 69/06; A01K 99/00

(52) U.S. Cl. 43/4.5; 43/100

(57) ABSTRACT

Herein we describe crustacean fishing traps having degradable cull panels, as well as methods for ensuring that such traps have reduced functionality after becoming derelict. Derelict crab and lobster traps have a negative economic and ecological impact, and thus it is advantageous to use crustacean fishing traps that will lose their ability to catch and retain fish over time. Incorporating degradable cull panels into such traps provides an effective, economical solution. Suitable degradable cull panels are described herein.

### CROSS-REFERENCE TO RELATED APPLICATIONS

This application is a continuation-in-part of co-pending U.S. patent application Ser. No. 12/714,370, filed on Feb. 26, 2010, which is a continuation-in-part of co-pending U.S. patent application Ser. No. 12/394,917, filed Feb. 27, 2009, which claims the benefit of and priority to U.S. Provisional Patent Application Ser. No. 61/032,266, filed Feb. 28, 2008, the entire disclosures of which are incorporated by reference herein.

### STATEMENT REGARDING FEDERALLY SPONSORED RESEARCH AND DEVELOPMENT

This invention was made with government support under Grant Numbers NA17AC2806, NA06NOS4630027 and NA09NMF4520027, awarded by the National Oceanic and Atmospheric Administration. The government has certain rights in the invention.

### FIELD OF INVENTION

The field of the invention relates to traps and methods for catching crabs and other crustaceans.

### BACKGROUND OF THE INVENTION

Derelict (i.e., lost or abandoned) commercial fishing gear, including nets and traps, can present safety, nuisance, and environmental impacts in estuarine waters. Blue crabs and various fish species that are entrapped and die in derelict traps can act as an attractant to other crabs, resulting in a self-baiting effect. Derelict fishing gear damages sensitive habitat and continues to capture both target and by-catch species, a process known as “ghost fishing”, leading to reduced fitness and significant acute and delayed mortalities. Animals captured in derelict traps can experience starvation, cannibalism, infection, disease, and prolonged exposure to poor water quality (i.e., low dissolved oxygen).

The number of derelict crab traps in the nation's estuaries is unknown. Typically, traps (also known as “pots”) can become derelict for a number of reasons, e.g., buoy lines can be severed by vessel propellers or break due to age, buoy materials can fail, storms can roll the traps pulling the buoy below the surface, and traps can be vandalized or abandoned. In a pilot study in Virginia, the density of derelict pots in a specific crab fishing sector was determined to be about one pot per 28 square meters (587 ghost pots/16,400 m²) (Havens, K. J., et al. “The effects of derelict blue crab traps on marine organisms in the lower York River, Virginia”, North American Journal of Fisheries Management (2008), 28, pp. 1194-1200).

It has been suggested that 250,000 derelict crab traps are added to the Gulf of Mexico annually, based on an estimated 25% loss/abandonment rate and an annual total number of traps fished commercially of approximately 1 million. The Gulf States Marine Fisheries Commission has estimated blue crab derelict fishery losses of as high as 4 to 10 million crabs a year in Louisiana (Guillory, V., et al., Proceedings: Blue Crab Mortality Symposium, Gulf State Marine Fisheries Commission (2001) Ocean Springs, Miss., pp. 28-41). A trap removal program in the Virginia portion of Chesapeake Bay has removed over 30,000 derelict traps from December 2008 to February 2012. Derelict pots have been shown to capture between 50 and 100 blue crabs per trap per season (Havens et al. 2008). In the Chesapeake Bay, over 600,000 traps are deployed annually and the annual loss rate of traps is estimated to be between 10 and 30% of those deployed. Since derelict traps are continually added to the system and traps can continue to capture animals for several years, a method to disarm pots that become lost is desired.

The effect of derelict blue crab traps on diamondback terrapins (Malaclemys terrapin) and commercially important finfish is significant, and various states and regions have enacted measures to reduce the ecological and economic impacts of derelict traps. For example, the state of Florida enacted regulations (CH 46-45, F.A.C., effective Jan. 1, 1995) establishing degradability requirements for blue crab traps. Traps are considered legal according to these regulations if a non-degradable implement (such as a panel) is secured to the trap using degradable materials such as jute twine or a corrodible hook. Unfortunately, many blue crab traps having such degradable connections continue to trap and retain fish and crabs long after the degradable part has degraded. This is because the non-degradable implement is often not released from the trap even after the degradable component degrades (e.g., barnacles can create secondary attachment points). The same issues can also occur with lobster traps.

It is desirable for crab traps to have cull rings, also called escape rings or escape hatches, to allow small and juvenile crabs to escape the trap. Typically, such cull rings have an inside diameter of at least 2.25 inches. For example, the state of Florida enacted regulations (CH 46-45, F.A.C., effective Jun. 1, 1994) requiring all blue crab traps to have at least 3 unobstructed escape rings installed, each with a minimum inside diameter of 2.375 inches. Lobster traps also are required to have escape hatches of varying sizes, with the size dependent on the jurisdiction.

There remains a need for an improved degradable crustacean trap that, within a period of months after it becomes derelict, loses its ability to trap fish and crustaceans. To reduce the economic burden on fishermen, it would be advantageous if a degradable implementation could be inexpensively incorporated into existing traps for lobsters or crabs, thereby providing the desired degradability in derelict traps without requiring the purchase of expensive new traps. Ideally, any such implementation would (i) not functionally degrade within the first eight months of being actively fished, such that during that period there would be no deleterious impact on fishing performance, and (ii) functionally degrade within eight months from the point of abandonment if the trap becomes derelict (i.e., it becomes abandoned and is continuously submerged in a marine environment). From these two functional requirements, the improved implementation would have a rate of decay which is slower during the period when the crustacean trap is being actively fished in a marine environment, and faster when the trap becomes derelict.

### BRIEF SUMMARY OF THE INVENTION

A modification to mitigate impact of lost crustacean traps may be considered a viable and effective option if: 1) the modification renders the trap ineffective at capturing marine life within eight months of abandonment of the trap, 2) any material used in the modification, once degraded, is environmentally benign, 3) the modification is relatively inexpensive and easy to install in order to be of practical use, and 4) catches of target crustacean species are maintained (i.e., the modification does not repel crustaceans or fail during a fishing season). To meet the above criteria, we developed a degradable cull panel that typically incorporates a cull ring (also known as an “escape ring” or “escape hatch”) and functionally degrades over time when submerged in a marine environment. The degradable cull panels, once degraded, create an opening in the trap that is comparable to the entrance funnel size and therefore allows the targeted catch species (and other trapped fish) to escape. In practical terms, anything that can enter the pot is then also able to escape.

Herein we describe a method for reducing ghost fishing in abandoned crustacean traps that utilizes a degradable cull panel that (i) physically prevents escape of mature crustaceans targeted by the crustacean trap during a single fishing season or approximately 8 months and (ii) functionally degrades within 8 months when abandoned (i.e. continuously soaked in a marine environment) such that said degradable cull panel no longer physically prevents escape of said mature crustaceans. During the time that a degradable cull panel is actively fished, the panel is mostly submerged in a marine environment and regularly brought to the surface to harvest the crustaceans. When a trap becomes derelict, the degradable cull ring panel continuously soaks in the marine environment.

Assuming a linear rate of decay throughout both the period when a pot is actively fished and when it becomes derelict, then it would be almost impossible for a material to fulfill both of the functional requirements described above. In other words, assuming this linear decay, in order to ensure sufficient durability during the period of active fishing of 8 months, degradable cull panels would not be assured of failing within a period of less than 8 months after becoming derelict. A novel feature of the method is that the degradable cull panel degrades more slowly when actively fished in a marine environment than when continuously soaked in a marine environment.

Herein, we describe a novel degradable cull panel for crustacean fishing traps that is capable of such a feat. We have identified a polymer that degrades in a marine environment and has the unexpected advantage of degrading substantially more slowly when actively fished in a marine environment than when continuously soaked in a marine environment. The panels are made from polyhydroxyalkanoate polymers having a tensile strength of at least 23 mPa when subjected to ASTM method D638, and a tensile elongation at break of at least 6% when subjected to ASTM method D638. This combination provides sufficient strength and toughness under use conditions to reduce the likelihood of premature failure due to brittleness. In some embodiments of the invention, the degradable cull panels include an escape ring that allows sublegal sized crustaceans to escape from the crustacean trap.

While degradable cull panels can in theory be made from any materials that degrade under typical use conditions, i.e., an underwater marine environment, the methods and degradable cull panels of the present invention require that the degradable cull panels are made from a polyhydroxyalkanoate polymer. Moderating the rate of degradation can be achieved, for example, by altering any of a number of factors, including but not limited to: the molecular weight of the polymer, the composition of monomer building blocks, the choice of or concentration of plasticizer of other additives, a coating on the polymer, surface imperfections, or the design of the degradable cull panel, in particular its thickness.

### BRIEF DESCRIPTION OF THE DRAWINGS

The summary above, and the following detailed description, will be better understood in view of the drawings which depict details of preferred embodiments.

FIG. 1 shows a line graph plotting, as a function of time, the percentage loss of degradable cull panels comprised of different materials. Individual data points from field trials, as well as the lines of best fit for each material, are shown.

FIG. 2 shows an enlarged version of the data lines of best fit presented in FIG. 1.

FIG. 3 shows a line graph plotting, as a function of time, the percentage loss of weight of polycaprolactone (PCL) degradable cull panels that were either fished or continuously soaked. Individual data points from field trials, as well as the lines of best fit for the fished and continuously soaked degradable cull panels, are shown.

FIG. 4 shows a line graph plotting, as a function of time, the percentage loss of weight of polyhydroxyalkanoate (PHA) degradable cull panels that were either fished or continuously soaked. Individual data points from field trials, as well as the lines of best fit for the fished and continuously soaked degradable cull panels, are shown.

FIG. 5A shows a line graph plotting, as a function of time, the percentage loss of weight of a representative PHA degradable cull panel that is abandoned at 8 months. FIG. 5B shows a line graph plotting, as a function of time, the percentage loss of weight of a representative PHA degradable cull panel that is abandoned at 3 months.

FIG. 6A shows a schematic top view of a representative degradable cull panel. FIG. 6B shows a schematic top view of another representative embodiment of a degradable cull panel wherein the panel has an open lattice structure.

FIG. 7 shows a perspective image of one embodiment of the degradable cull panels containing fuses.

FIG. 8 shows a perspective view of a blue crab trap 100 which includes entrance funnel 101 and degradable cull panels 102 and 103, each of which contains an escape ring 104 within said degradable cull panels. Degradable cull panels 102 and 103 are distinct, representative embodiments of degradable cull panels of the present invention.

FIG. 9A shows a schematic diagram of a blue crab trap having a degradable cull panel prior to the onset of degradation. FIG. 9B shows a schematic diagram of a blue crab trap having a degradable cull panel that has degraded.

FIG. 10A shows an image of a degradable cull panel of the present invention prior to being attached to a crab trap; and FIG. 10B shows an image of a degradable cull panel of the same composition and design as the panel in FIG. 10A, albeit substantially degraded after six months of field testing.

FIG. 11A shows the front image and FIG. 11B shows the back image of an unused PHA degradable cull panel, and FIG. 11C shows the front image and FIG. 11D shows the back image of a comparable PHA degradable cull panel that had been continuously submerged (i.e., not actively fished) for 169 days. The panels shown in FIG. 11 were produced using the same injection mold.

FIG. 12 shows a degradable cull panel for a lobster trap.

FIG. 13 shows an image of a degradable cull panel of the present invention, made from PCL, prior to being attached to a crab trap.

### DETAILED DESCRIPTION OF THE INVENTION

The present invention is directed to crab traps and lobster traps having degradable cull panels, and methods for reducing ghost fishing by using degradable cull panels in crab traps and lobster traps that may eventually become derelict. The term “degradable cull panel” refers to a panel that can be secured to a crab or lobster trap, wherein the panel degrades under marine conditions to yield an opening in the trap that permits trapped fish and shellfish to escape from a derelict trap. The degradable cull panels can be used with traps for blue crabs (Callinectes sapidus) or other species of crabs, or lobsters.

There is an important time component to the desired degradation for a degradable cull panel. When a crustacean trap is abandoned, the degradable cull panel is continuously submerged in a marine environment. The degradable cull panel should functionally degrade to allow mature crabs or lobsters to escape within 12 months, more preferably within 8 months, and even more preferably within 6 months from the point of abandonment. This functional requirement for the time of degradation will prevent the derelict traps from continuing to retain fish that have entered the trap. The other functional requirement is that the degradable panel must remain intact for the entire fishing season during normal use. Fishing seasons vary by jurisdiction, but often extend for periods of about 8 months. This lower limit for the time of degradation is important to prevent loss for commercial fisherman, an important feature for any new technology. As described previously, it is not easy to balance the need for sufficient durability while the trap is actively fished with the need for rapid degradation once a trap becomes derelict, and it is further complicated by the fact that underwater marine environments can have substantial variability in terms of pressure, temperature, salinity, and biodiversity, all of which can impact the rate of degradation.

Herein we describe a method for reducing ghost fishing in abandoned crustacean traps comprising: attaching a degradable cull panel to a crustacean trap and fishing for crustaceans with said crustacean trap; wherein said degradable cull panel: (i) is made from a polyhydroxyalkanoate material; (ii) physically prevents escape of mature crustaceans targeted by the crustacean trap during a single fishing season or approximately 8 months; (iii) functionally degrades when continuously soaked in a marine environment (i.e., after the trap becomes derelict), such that said degradable cull panel no longer physically prevents escape of said mature crustaceans; and (iv) degrades more slowly when actively fished in a marine environment than when continuously soaked in a marine environment. In some embodiments of the invention, the degradable cull panels include an escape ring that allows sublegal sized crustaceans to escape from the crustacean trap. Note that functional degradation of a degradable cull panel, such that it fails to retain the targeted crustacean species and by-catch, does not require complete biodegradation at the time of failure. Instead, the degradable cull panels can fail in many different ways. For example, a large hole can open up within the degradable cull panel, or the degradable cull panel can fracture such that a large piece falls off, or the degradable cull panel can become detached from one or more points to which it was attached to the crustacean trap (i.e., such that it is partially or fully detached from the trap), or any other means or combinations thereof to provide an opening through which fish can escape from the trap. Subsequent to the time of failure, a degradable cull panel of the present invention will completely degrade in a marine environment.

Since fishermen do not want “solutions” to the problem of ghost fishing that are costly in terms of money or labor, any commercially viable degradable cull panel should last at least one fishing season (e.g., 8 months, although the legal season varies according to state regulations). It would be particularly problematic if degradable cull panels fail while being fished, as an entire trap full of crabs or lobsters could escape, costing the fishermen significant money and reducing the likelihood that the fishermen would subsequently use or recommend the product. Accordingly, it is important for degradable cull panels to last at least eight months while being regularly fished. Additionally, it is important for degradable cull panels to break down quickly once the crustacean trap to which they are attached becomes derelict. For example, it would be problematic if a derelict pot was pulled up from the bottom of the Chesapeake Bay two years after being abandoned, and the supposedly degradable cull panels were still intact, and the trap was still capturing and retaining crabs.

This is a difficult balancing act, as one would like a degradable cull panel that has (i) little or no chance of degrading sufficiently to allow mature crabs or lobsters to escape while being actively fished, yet (ii) quickly degrades once the crustacean trap becomes abandoned such that the trap no longer effectively fishes and thus does not deplete the fishery. During the time that a degradable cull panel is actively fished, the panel is mostly submerged in a marine environment and periodically brought to the surface to harvest the crustaceans. When a trap becomes derelict, the degradable cull panel continuously soaks in the marine environment. Assuming a linear rate of decay throughout both the period when a pot is actively fished and when it becomes derelict, then it would be almost impossible to satisfy the above-described balancing act. In other words, assuming this linear decay, if sufficient durability was ensured during the period of active fishing of 8 months, then degradable cull panels would not be assured of failing within a period of less than 8 months of becoming derelict.

Fortunately, we have identified a polymer that degrades in a marine environment and has the unexpected advantage of degrading substantially more slowly when actively fished in a marine environment than when continuously soaked in a marine environment.

Many plastics that are advertised as biodegradable were tried under appropriate environmental conditions. For example, polylactic acid (PLA) is widely available and inexpensive. Unfortunately, it did not noticeably degrade when submerged in a marine environment under the desired experimental conditions. In fact, we identified only two plastics, polycaprolactone (PCL) and polyhydroxyalkanoates (PHA), that successfully and completely degrade in the targeted marine environment without producing environmentally deleterious byproducts. Different designs of the degradable cull panels, and different formulations of the biodegradable polymers, were tested with the intent of identifying combinations that did not fail within 8 months of being fished regularly, but ideally would fail within the next 8 months if abandoned.

In a long term study of degradable cull panels made from PCL and PHA, degradable cull ring panels were deployed in crab traps that were either actively fished or submerged continuously, see Example 1. The PCL grade that was used was CAPA® 6500, which was selected over other grades of PCL (e.g., CAPA® 6400 and CAPA® 6800) based on promising results in preliminary studies. The PHA grade that was used was Mirel™ P1004, a polyhydroxyalkanoate formulation (including additives and mineral fillers) with high toughness, also based on promising results in preliminary studies relative to other polyhydroxyalkanoates. With the plastics and designs used in Example 1, degradable cull panel failure typically is unlikely to occur until degradation by weight exceeds 20%, while failure is very likely to occur when degradation by weight exceeds 40%. In other words, provided the extent of degradation is less than 20%, the degradable cull panel is generally still suitable for use in fishing. Between 20% and 40% degradation, failure is fairly likely, and fishing with the degradable cull panel would not be advisable, since failure could occur with a trap full of valuable crabs or lobsters. Above 40% degradation, it is likely that the degradable cull panel will fail, and the targeted crustacean species could escape. With the plastics and designs used in Example 1, an ideal degradable cull panel: (i) will not reach 20% degradation for at least 8 months while the panel is regularly fished, and (ii) will reach 20% degradation, and ideally 40% degradation, within six months of being continuously submerged.

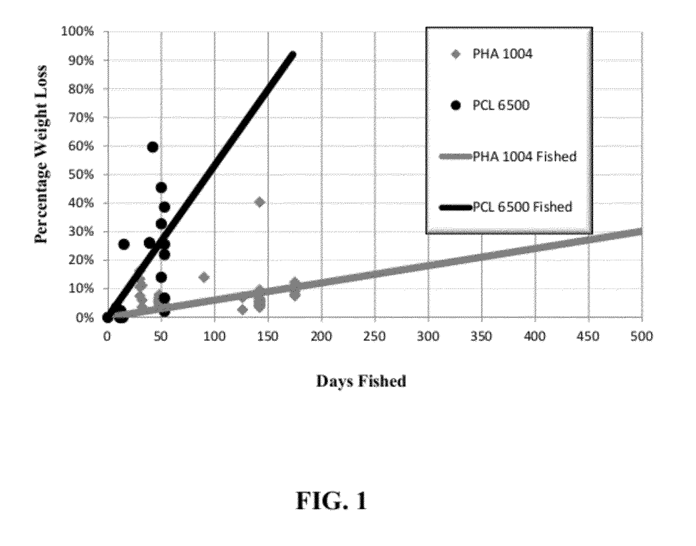

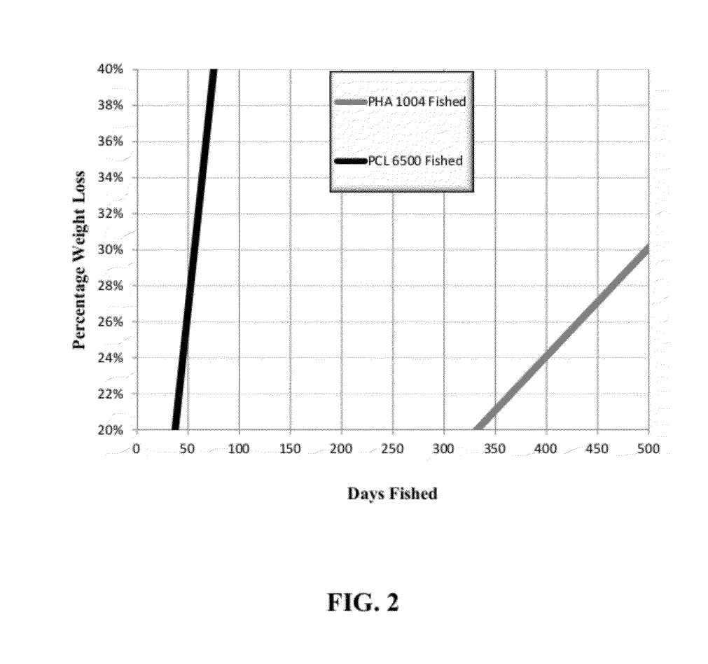

Utilizing a set schedule, the cull ring panels were removed from the water, dried, and weighed at specified times. The data was plotted as percentage weight loss per unit time. FIG. 1 compares the degradability, during a period of active fishing, of degradable cull panels made from PHA and PCL formulations as described above. FIG. 2 shows an enlarged version of FIG. 1, highlighting the 20% to 40% degradation range. As is apparent in FIGS. 1 and 2, degradable cull panels made from PCL (CAPA® 6500) that were actively fished reached the 20% degradation threshold within about 45 days on average. This is too soon for commercial viability, although thicker panels could potentially be used, improving durability albeit with a corresponding increase in cost of goods. Degradable cull panels made from PHA (Mirel™ P1004) panels that were actively fished reached the 20% loss threshold at about 330 days, based on line-fitting and assuming a linear rate of decay during the period of active fishing. This amount of time is close to 11 months, well beyond our desired threshold durability of one long fishing season (8 months).

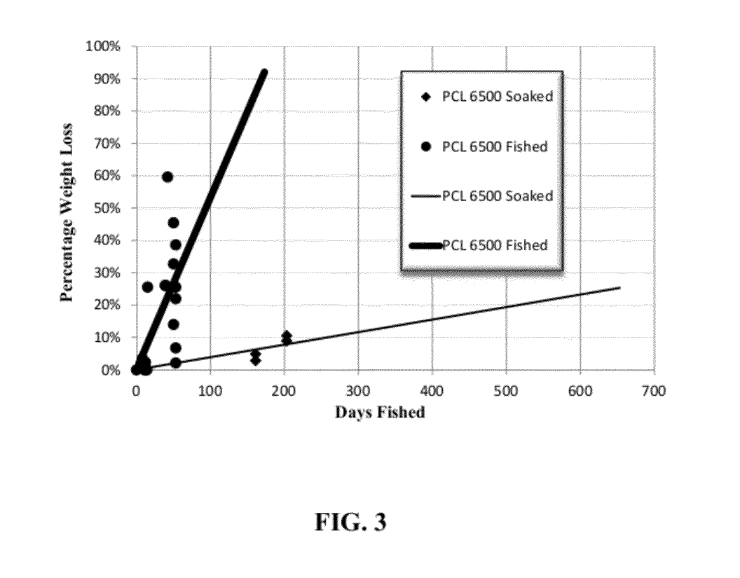

FIG. 3 compares PCL panels that were actively fished to panels that were continuously soaked. As previously described, PCL panels that were actively fished reached the 20% degradation threshold within about 45 days on average. PCL panels that were continuously soaked, modeling an abandoned trap, did not reach the 20% degradation threshold until about 520 days, using line-fitting techniques and assuming a linear rate of decay. Unfortunately, as shown, these degradable panels did not degrade quickly after being continuously submerged. In fact, the rate of degradation was slower after being continuously submerged than when the panels were being actively fished. In other words, when degradable cull panels made from PCL were fished regularly, the degradation rate was increased relative to the degradation rate when PCL panels were continuously soaked. That, unfortunately, is the reverse of the desired property. It would be very difficult to provide a PCL degradable cull panel that would, with a high degree of probability, be able to both (i) withstand 8 months of fishing without failing, and (ii) fail within 8 months, preferably 6 months, of being continuously submerged.

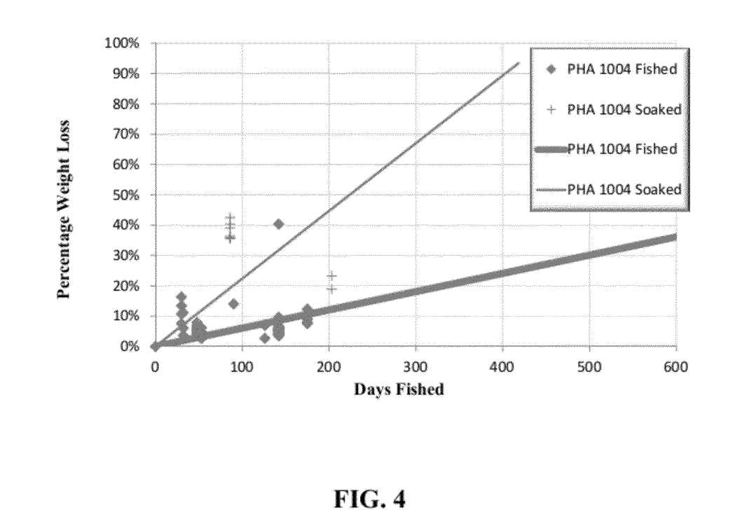

FIG. 4 compares PHA degradable cull panels that were actively fished to PHA panels that were continuously soaked. As previously described, PHA panels that were actively fished were calculated to reach the 20% degradation threshold within about 330 days. The data suggest that PHA panels that were continuously soaked were calculated to reach the 20% degradation threshold on average at about 90 days, and reach the 40% degradation threshold on average in about 180 days. In contrast to PCL, degradable cull panels made from PHA had the unexpected advantage of degrading at a faster rate once continuously submerged than while being actively fished. This is an enormous benefit, as it allows one to meet the difficult balancing act described above. In fact, this important property allows a manufacturer to design and produce a degradable cull ring panel of sufficient toughness to almost certainly last at least 8 months while being actively fished, and to degrade to a point of almost certain failure within 8 months of being continuously submerged.

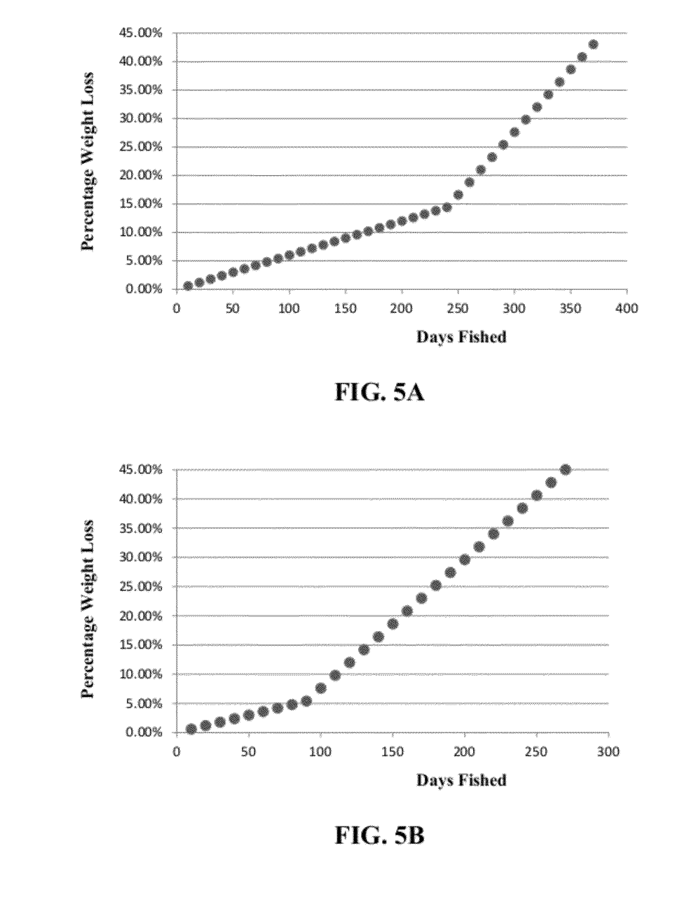

FIGS. 5A and 5B demonstrate the implications of the dual rate of degradation. FIG. 5A shows the degradation as a function of time for a representative PHA panel attached to a crustacean trap. Until approximately 8 months, the trap is actively fished, as shown by the dotted line through 240 days. The trap then becomes derelict, and the panel is continuously soaked. The increased rate of degradation is shown by the dotted line after 240 days. FIG. 5B shows an analogous graph for a crustacean trap that is abandoned after 90 days.

Without wishing to be bound by theory, we believe that an explanation for this important advantage of degradable cull panels made from PHA is that the degradation processes may rely on organisms that are susceptible to ultraviolet light and/or oxygen. When the degradable cull panels are periodically removed from the water during the fishing process (e.g., to harvest the trapped crustaceans and re-bait the traps), the exposure to light and oxygen may slow the degradation process. Additionally, the rapid movement of the trap during the fishing process, both from the banging that occurs on land, as well as the movement through water when the trap is being pulled from the water and returned to the water, could result in sloughing of organisms and adversely impact the degradation process.

While degradable cull panels made from PHA have this significant advantage, the brittleness of PHA rendered some PHA formulations unsuitable for use according to the methods of the invention. Even with only modest degradation by weight, some PHA formulations (e.g., MIREL™ P4001 and MIREL™ P1003, both available from Telles Inc. of Lowell, Mass.) were overly brittle when incorporated into our test designs, and failed during field testing long before substantial degradation had occurred. The field testing process subjects degradable cull panels not only to being banged around by watermen, but also to challenges from crabs and other aquatic animals such as turtles. For example, degradable cull panels made from MIREL™ P4001 were field tested by five commercial watermen using 10 crab traps each, with two panels per pot. Of the 100 degradable cull panels tested, all failed prematurely during the fishing season and needed to be replaced, some of them multiple times. Generally, the mode of failure of these MIREL™ 4001 degradable cull panels was fracture at the edges. It is conceivable that improved designs or processing technique could eliminate or reduce the problems, but it was preferable to identify improved formulations, and clearly there are economic advantages to keeping the degradable cull panels as thin as possible, thereby keeping material costs low.

Continued field testing identified a superior formulation that did not have significant failures due to brittleness. Enhanced toughness and ductility are key features of PHA polymers that are particularly useful for degradable cull panels. Accordingly, in order to achieve the desired durability of degradable cull panels while they are being actively fished, it is important to use PHA formulations having tensile strength of at least 23 mPa when subjected to ASTM method D638, and a tensile elongation at break of at least 6% when subjected to ASTM method D638. For example, neither MIREL™ P4001 nor MIREL™ P1003 have tensile elongations at break of at least 6.0%, whereas MIREL™ P1004 formulations meet the above requirements (i.e., a tensile strength of 24 mPA, and a tensile elongation at break of 7%), and can be used to provide degradable cull panels of the present invention.

PHA polymers are true biopolymers, produced in nature by bacterial fermentation of sugar and lipids. They are linear polyesters, and more than 150 different monomers can be combined within this family to give polymers with a wide variety of properties. Some common PHA polymers include poly-3-hydroxybutyrate, polyhydroxyvalerate, and co-polymers thereof.

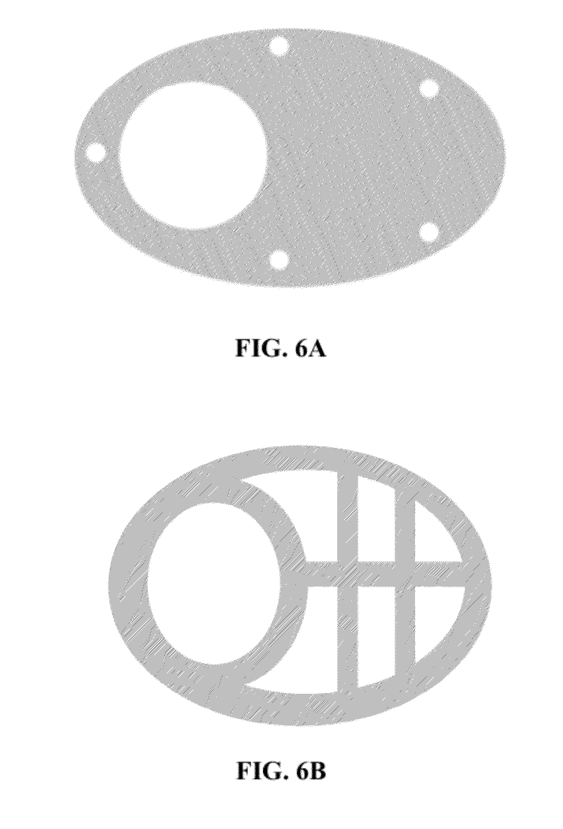

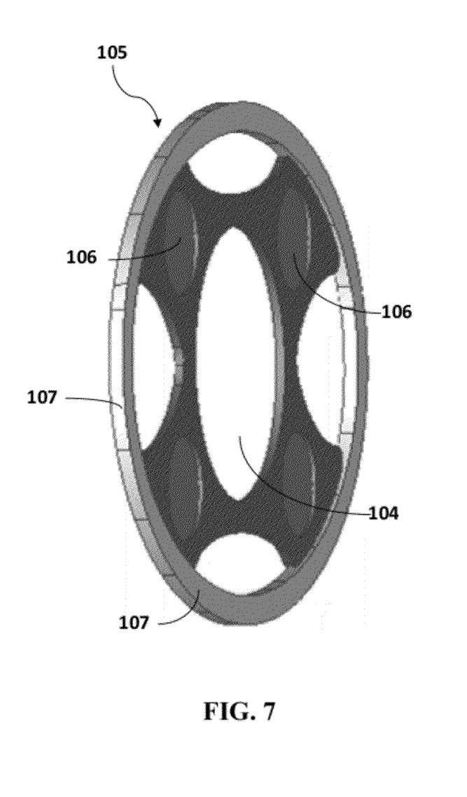

The degradable physical barrier of the degradable cull panels can take a number of forms, including a solid panel, a lattice, a mesh, a gated structure, or any other structure that prevents the escape of mature crustaceans of the targeted crustacean species before the degradable barrier breaks down. For example, FIG. 6A and FIG. 6B depict representative degradable cull panels suitable for attachment to crab traps. In these degradable cull panels depicted in FIG. 6A and FIG. 6B, the thickness is uniform throughout the degradable cull panel. FIG. 7 shows a perspective image of a degradable cull panel suitable for attachment to a crab trap. In this embodiment, the thickness is not uniform throughout the panel. In some embodiments, the degradable cull panel comprises a solid, impervious barrier surrounding the escape ring. In alternative embodiments, the degradable cull panel can have a lattice structure, a hub-and-spoke arrangement, or any other design that is suitable to prevent escape of the targeted catch, while also rendering the cull panel degradable within the preferred time frame.

The methods and degradable cull panels of the present invention are for use in crustacean fishing traps, and more specifically for use in fishing of crustaceans of the order Decapoda within the class Malacostraca, and even more specifically, for use in fishing of crabs and lobsters, in particular crabs selected from the species Callinectes sapidus (blue crab), Metacarcinus magister (Dungeness crab), Paralithodes camtschaticus (red king crab), and Chionecetes spp. (snow crabs), and lobsters selected from the species Homarus americanus (American lobster) and Panulirus argus (Caribbean spiny lobster).

When the degradable cull panel is for a crab trap, the degradable cull panel typically includes an opening (i.e., an escape ring) sufficient for escape of small crabs, with the size of said escape ring typically specified in local fishing regulations. This escape ring is typically circular, with a diameter of greater than two inches, although it is not required to be circular, notwithstanding the “ring” nomenclature. The degradable cull panel is larger than the escape ring itself, and the degradable cull panel must have an area of greater than 12 sq. inches, more typically greater than 16 sq. inches, to fulfill the desired function of allowing trapped fish and shellfish to escape. When used in traps for blue crabs, the degradable cull panel usually has an area of less than 30 sq. inches, more typically less than 24 sq. inches, in order to reduce material costs. When used in traps for Dungeness crabs, the degradable panel is much larger. For example, in one embodiment of a degradable cull panel suitable for attachment to a Dungeness crab trap, the panel has oval shape with length of 8.5 inches, width of 5 inches, and an escape ring with a 4.375 inch diameter. Typically, the degradable cull panel has a size comparable to the entrance openings of the crab trap.

When the degradable cull panel is for a lobster trap, the escape ring should have an area of at least the size specified in the applicable fishing regulations. Typically, escape rings in lobster traps are not circular and are often called “escape hatches”, a term that can be used interchangeably with escape ring or cull ring. The degradable cull panel has a significantly larger area than the escape ring, sufficient to allow trapped adult lobsters to escape. Non-degradable escape hatches are deployed in typical prior art lobster traps, and are generally simple plastic or wire squares that have an opening of about 2 inches by 6 inches, although the size varies by region according to the regulations. The escape hatches are customarily placed in the parlor section of the trap. The hatches are designed to allow small lobsters, fish, and crabs to escape, while marketable lobsters are retained as well as larger, non-targeted fish. Existing mechanisms to allow the escape of animals after a trap becomes derelict mainly involve a cut panel that is held by degradable string. The methods and degradable cull panels of the present invention utilize fully degradable plastic that, upon decomposition, turns the escape hatch into a larger section to allow all trapped organisms that can enter to escape. This provides a mechanism to render abandoned or lost traps ineffective in trapping and killing organisms. This approach is cost-effective, easy to enforce, and user-friendly because replacement degradable cull panels are easy to install.

The degradable cull panel design typically incorporates an escape ring of regulation size and can be altered to fit a particular state's requirements. In other words, the degradable cull panels comprise a degradable physical barrier, typically surrounding or adjacent to a degradable cull ring (escape hatch) of a size typically used in crustacean fishing traps for crabs or lobsters. For example, under normal use conditions for crab fishing, the degradable barrier remains functionally intact, preventing the escape of large crabs, while small crabs escape through the escape ring. Since escape rings are typically mandated, commercial fishermen have to purchase and attach regulation rings to their traps. By including a regulation escape ring in each degradable panel, additional escape rings will not need to be purchased and installed, thereby minimizing total costs and promoting wide acceptance. However, the methods and degradable cull ring panels of the present invention contemplate embodiments that are degradable cull panels but do not include an escape ring.

The methods and degradable cull panels of the present invention require that the degradable cull panels are made from a polyhydroxyalkanoate polymer. Moderating the rate of degradation can be achieved, for example, by altering any of a number of factors, including but not limited to: the molecular weight of the polymer, the choice of or concentration of plasticizer of other additives, a coating on the polymer, surface imperfections, or the design of the degradable cull panel, in particular its thickness. The panels are made from polyhydroxyalkanoate polymers having a tensile strength of at least 23 mPa when subjected to ASTM method D638, and a tensile elongation at break of at least 6% when subjected to ASTM method D638. This combination provides sufficient strength and toughness under use conditions to reduce the likelihood of premature failure due to brittleness.

While many plastics have been described as being degradable, it is important to use only a polymer that legitimately degrades in a marine environment into monomers and oligomers. In order to be environmentally benign, it is advisable not to use plastics that will break apart into very small pieces that are themselves not biodegradable, and thus would accumulate in marine species. It is not desirable, for example, to use polypropylene formulations wherein the macrostructure of the plastic breaks down in a marine environment, but small pieces of polypropylene that do not biodegrade would then be ingested by marine organisms. The degradable cull panels of the present invention are comprised of PHA and designed such that the entire panel is degradable. The unitary design of the cull ring panel allows for a simplified manufacturing process.

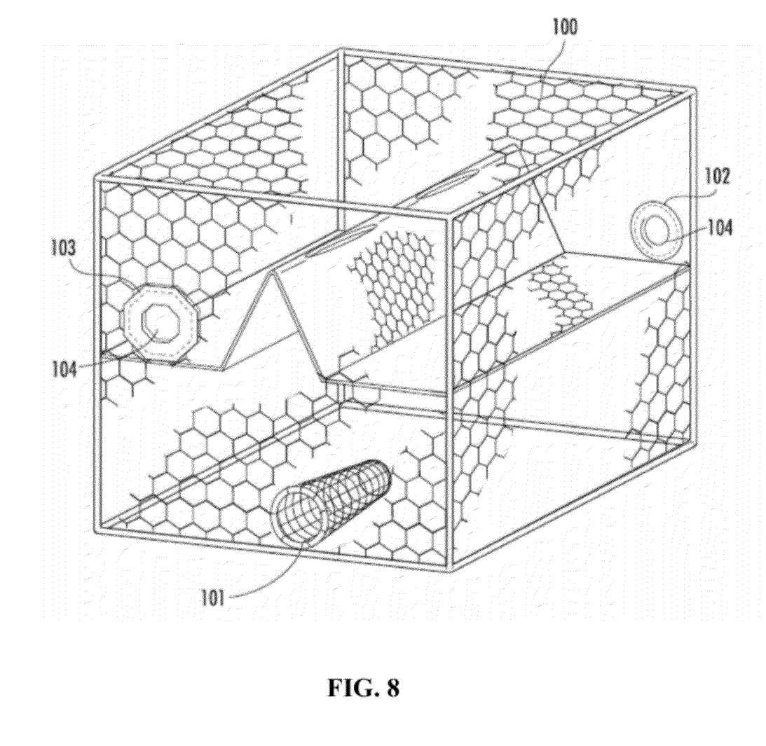

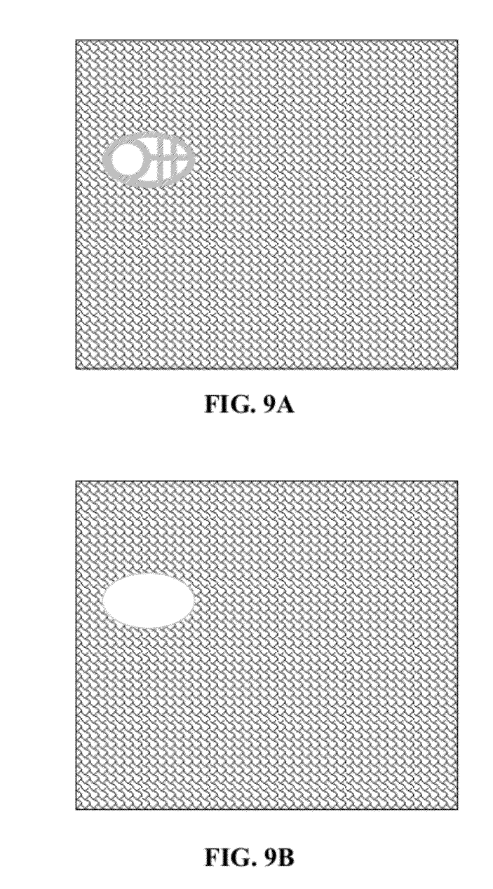

A degradable cull panel can be affixed to the wall of a crustacean trap in the same manner as escape rings are currently affixed. For example, the degradable cull panels can be incorporated easily into existing crab traps simply by cutting the existing wire mesh framework sufficiently to produce a hole large enough to accommodate the degradable cull panel, which is then secured into place using methods known in the art, including wire clips or ties, which themselves may or may not be made from degradable materials. In typical embodiments, degradable cull panels can be introduced at the following locations: the junction of two panels, in the upper chamber of a crab trap, and/or touching the upper partition floor of a crab trap or other locations where escape rings are typically installed. For example, FIG. 8 depicts a representative crab trap 100 having an entrance funnel 101 and degradable cull panels 102 and 103, each containing an escape ring 104 therein. FIG. 9A is a schematic diagram showing a crab trap with an intact degradable cull panel, while FIG. 9B shows the same crab trap after the degradable cull panel has degraded. Commercial waterman typically must attach escape rings to traps to adhere to local fishing regulations. Attaching a slightly larger biodegradable panel containing a cull ring is not significantly more burdensome.

A reduction in the entrapment and potential injury or mortality of undersized crabs can be realized by proper placement of cull rings within crab traps and has implications for the placement and design of degradable cull panels. Placement of cull rings flush with the upper chamber floor or partition substantially increases the odds of escape within four hours of capture relative to crab traps with cull rings higher on the trap wall. Accordingly, it may be beneficial to utilize a degradable cull panel design and placement wherein the escape hatch of the degradable cull panel is placed flush with the upper chamber floor.

FIG. 8 shows a perspective view of a blue crab trap 100 which includes entrance funnel 101 and degradable cull panels 102 and 103, each of which contains an escape ring 104 within said degradable cull panels. Degradable cull panels 102 and 103 are distinct, representative embodiments of degradable cull panels of the present invention. The degradable cull panels are flush with the wall of the crustacean trap.

FIG. 9A shows a schematic diagram of a blue crab trap having a degradable cull panel prior to the onset of degradation. FIG. 9B shows a schematic diagram of a blue crab trap having a degradable cull panel that has degraded.

There was no evidence that degradable cull panels adversely affect crab catch. In two experiments, see Example 2 and 3, legal catches were similar (or greater) in abundance, biomass and size in experimental pots with degradable cull ring panels as compared to standard pots with standard cull rings.

Lost pots can become effective habitat for marine organisms if the pots are modified to become ineffective at trapping after being abandoned. The three dimensional structure provided by the approximate 0.6 m cube shape of lost pots has been shown to provide shelter to oysters Crassostrea virginica and other encrusting organisms. Other marine organisms such as mud crabs, gobies, pinfish and the lined seahorse Hippocampus erectus, northern pipefish Syngnathus fuscus, feather blenny Hypsoblennius hentz, and juvenile blue crab have been shown to use the encrusted pots as shelter. Our results indicate that properly designed degradable cull panels are an effective and efficient crustacean trap modification to reduce catch of lost and abandoned traps and transform a type of marine pollution into potential productive habitat.

In some embodiments, the degradable cull panels contain fuses that provide the user with a visual cue as to the extent of degradation that has occurred with the degradable cull panel. For example, FIG. 7 shows one embodiment of the degradable cull panels of the present invention suitable for attachment to crab traps. The degradable cull panel 105 contains an escape ring 104, along with four fuses 106 of various depths. In this embodiment, the escape ring has a diameter of 2.376 inches, and the four fuses have diameters of 0.92 inches. The oval degradable cull panel has a length of 6.5 inches and a width of 4.5 inches. The outer edge 107 of the degradable cull panel shown has a width of 0.25 inches, and a thickness of 0.1 inches. In other embodiments having a similar design, the outer edge has a width exceeding 0.25 inches to enhance durability. As is apparent from the drawing, in this embodiment, the thickness of the fuses is less than the thickness of the edge of the degradable cull panel (e.g., 0.04 inches). The thickness of the interior portion of the degradable cull panel is also less than that of the edges in this embodiment, with a thickness of 0.08 inches. There is often significant stress along the edge of the degradable cull panel, depending on the design, particularly in the vicinity of attachment points. Accordingly, in order to prevent premature failure of the degradable cull panel, it can be advantageous to reinforce the edges by making them thicker or wider. Note that FIG. 7 is a representative embodiment, but other embodiments of the invention can have different length, width, and/or thickness, as well as a difference in the overall design.

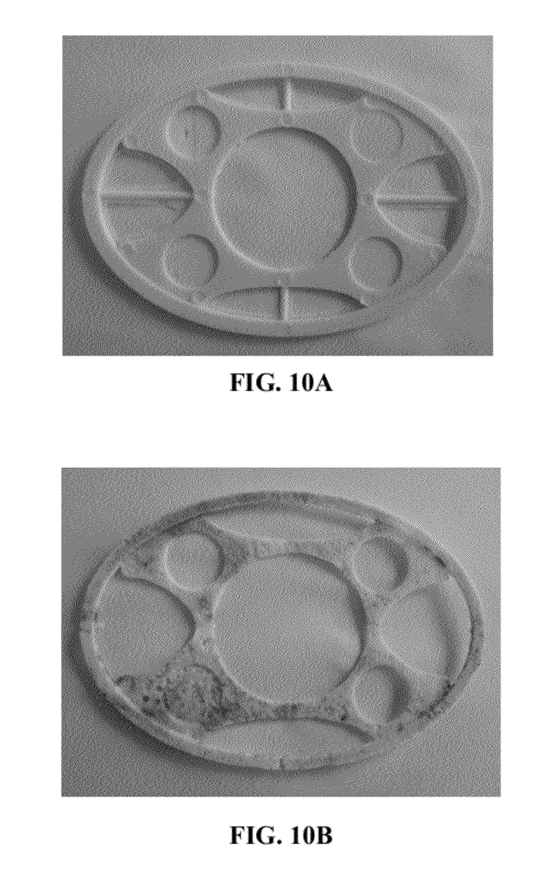

FIG. 10A shows an image of a degradable cull panel of similar design to that shown in FIG. 9. This image was taken prior to use in the field. FIG. 10B shows a degradable cull panel of the same design and materials as the one in FIG. 10A, albeit this time the image was taken after six months of field testing in a marine environment. Note the fuses are almost completely degraded, with only one of the four fuses remaining partially intact. Substantial degradation has clearly occurred at different positions of the cull panel, and the degradable cull panel, while still providing an effective physical barrier, is clearly getting close to a point at which a failure would be likely.

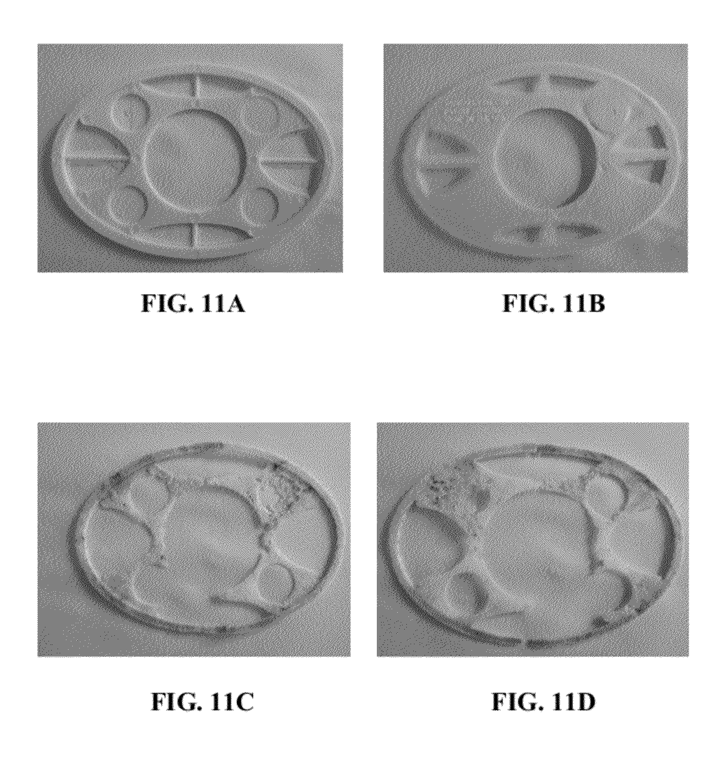

FIG. 11C and FIG. 11D show front and back images of a PHA degradable cull panel that was continuously submerged (i.e., not actively fished) for 169 days. FIG. 11A and FIG. 11B show front and back images of a comparable PHA degradable cull panel prior to use. If the panel shown in FIGS. 11C and 11D was attached to a crab trap, it would almost certainly fail when challenged by a crab. As is apparent from the images, after 169 days, much of the interior material had degraded, leaving a large gap. In fact, after 169 days, the panel had lost over 60% of its original weight, and the thickness of the outer ring had decreased from 2.95 mm when new to an average of 1.7 mm. Additionally, there are two cracks in the outer ring that would facilitate escape. If this panel was attached to a crab trap, and an entrapped crab pushed on this degradable cull panel at this stage, the degradable panel would likely snap or bend sufficiently that the crab could escape from the trap.

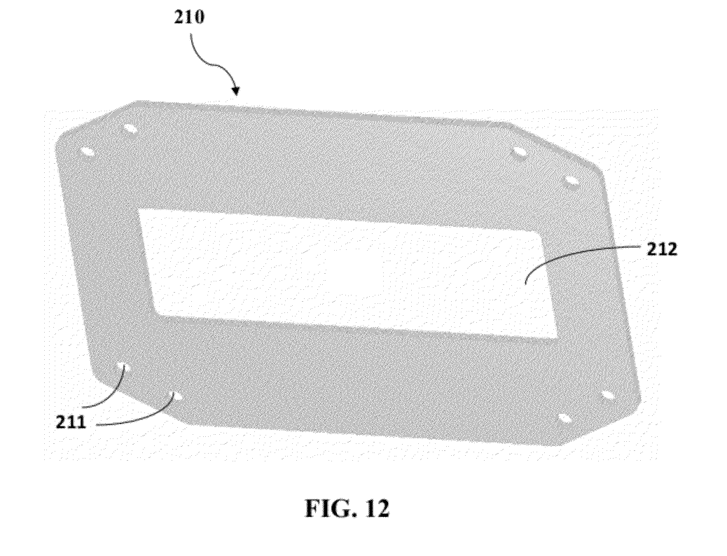

In a representative embodiment of the invention, a degradable cull panel for a lobster trap is depicted in FIG. 12. This degradable cull panel 210 has eight attachment points 211 (e.g., for wire clips), situated two in each corner. The escape hatch 212 is a rectangle having an area of 1.875 inches by 5.875 inches. The largest length of the degradable cull panel 210 depicted is 7.875 inches, and the largest width is 5.25 inches. The thickness of the degradable cull panel 210 is 0.125 inches (⅛ inch thick).

In the examples that follow, degradation is experimentally followed by monitoring the weight of (dried) degradable cull panels. Obviously, weight loss does not perfectly predict time to failure. There are many variables that impact when and if a degradable cull panel will fail (i.e., allow the targeted mature crustaceans to escape the crustacean trap through all or part of the degradable cull panel). Degradation is usually not consistent throughout the cull ring panel, and if there is sufficient degradation around two attachment points to the crustacean trap, then crustaceans typically can escape. The crustaceans themselves can have an influence by grabbing and clawing relatively weak points. The injection molding process can have an influence, and imperfections in the degradable cull ring panel as a result of, for example, poor plastic flow can increase the likelihood of failure. Handling of the trap and panels can have an impact, and obviously the water conditions and local environment will have an effect on the time to failure.

### EXAMPLES

The examples that follow are intended in no way to limit the scope of this invention but instead are provided to illustrate representative embodiments of the present invention. Many other embodiments of this invention will be apparent to one skilled in the art.

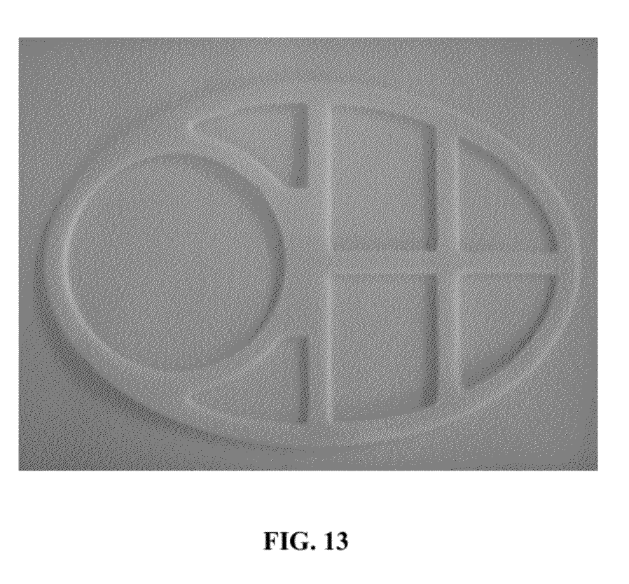

Example 1. In a long term study of degradable cull panels made from PCL and PHA, degradable cull ring panels were deployed in crab traps that were either actively fished or submerged continuously. The PCL grade that was used was CAPA® 6500 (supplied by Perstorp UK Ltd., Cheshire, United Kingdom), a high molecular weight polycaprolactone that showed promise in preliminary studies. The PHA grade that was used was Mirel™ P1004, a polyhydroxyalkanoate formulation (including additives and mineral fillers) with high toughness that showed promise in preliminary studies, whereas other polyhydroxyalkanoates were brittle and had a high failure rate when being actively fished, irrespective of the extent of degradation. Design of the PCL degradable cull panels is shown in FIG. 13 (an unused PCL degradable cull panel). Design of the PHA panels is shown in FIG. 11A and FIG. 11B. Utilizing a set schedule, the degradable cull panels were removed from the water, dried, and weighed at specified times. With the plastics and designs used in this example, degradable cull panel failure typically is unlikely to occur until degradation by weight exceeds 20%, and failure is very likely to occur when degradation by weight exceeds 40%.

As is apparent in FIG. 1 and FIG. 3, degradable cull panels made from PCL (CAPA® 6500) that were actively fished reached the 20% degradation threshold within about 45 days on average. As shown in FIG. 3, PCL panels that were continuously soaked, modeling an abandoned trap, did not reach the 20% degradation threshold until about 520 days. Setting aside any assumptions or line-fitting, none of the four PCL panels that were continuously soaked had greater than 11% degradation even after over 200 days of being submerged continuously in a marine environment, whereas more than half of the PCL panels that were regularly fished showed greater than 20% degradation within 53 days (and in many cases sooner than that). When degradable cull panels made from PCL were fished regularly, the degradation rate was increased relative to the degradation rate when PCL panels were continuously soaked.

Degradable cull panels made from PHA (Mirel™ P1004) panels that were actively fished reached the 20% loss threshold at about 330 days as shown in FIG. 1 and FIG. 4, based on line-fitting and assuming a linear rate of decay during the period of active fishing. In contrast, PHA panels that were continuously soaked (i.e., not regularly fished) reach the 20% degradation threshold on average at about 90 days, and reach the 40% degradation threshold on average in about 180 days (see FIG. 4). Of the eight PHA degradable cull panels that were continuously soaked, six of them reached at least 35% degradation within 86 days. The other two reached at least 18.5% degradation within 203 days. In other words, most of the samples failed or were on the verge of failure within 3 months. In contrast, of the 100 PHA degradable cull panels that were regularly fished, with weight sampling performed between 30 and 175 days, only one (out of 100) had reached the 20% degradation threshold at the time of its testing.

This is an unexpected and important result. PHA panels degraded faster when continuously submerged than when actively fished, which is ideal for the intended use of the degradable cull panels. This makes suitable, sufficiently tough PHA superior for use in degradable cull panels relative to other plastics, such as PCL, that degrade in a marine environment. Without the rigorous field-testing under actual use conditions, this important property of PHA would have gone unnoticed.

Example 2. Oval biodegradable cull panels were constructed of either polycaprolactone or polyhydroxyalkanoate. The length of the panel was 150 mm, the width was 100 mm at the widest point, and the thickness was 1.5 mm. Each degradable cull panel included an escape ring of 60 mm (2⅜ in) inside diameter (to correspond to the regulation cull ring size used in standard pots). An oval section of crab pot wire of the same size was removed from opposite sides of the upper chamber of the crab pot and the panels attached using polyamide (nylon) cable ties. Cull ring position was kept consistent for standard and experimental pots.

During the spring (March/April), early summer (May/June) and fall (October/November), two lines with 20 crab pots each (40 pots total) were fished by licensed commercial watermen in the Lower York River, Virginia. Each line consisted of 10 pairs of pots. The standard (control) crab pots had 2 cull rings and the experimental crab pots had 2 biodegradable cull ring panels. Pairs of pots were placed next to each other along the line (i.e. standard, experimental, standard, experimental). The two lines of pots were considered experimental units and the individual pots considered subsamples. Pots were fished in a manner consistent with commercial fishing practices in that early and late in the season, when catches decline, traps were fished over a 48 hour period, whereas in the middle of the season, when catches increase, the traps were retrieved daily. Experimental and standard pots were similarly baited with seasonally available bait: clams, Atlantic croaker, alewife and bluefish. The numbers and sizes of legal and sublegal crabs were recorded for each trap and fishing period. Legal status was determined in the field based on whether an individual crab could fit in a regulation sized cull ring (60 mm (2⅜ in)) for Virginia. Biomass was estimated from carapace width (CW) using the following equations known in the art:

Biomass_{female}=0.000355·2.571(CW)

Biomassₘₐₗₑ=0.00027·2.571(CW)

For each pot and sampling event, the number and biomass of crabs were summed and the mean catch size estimated. Within a given line (experimental unit), catch information was then averaged across subsamples for each sample date and pot type to obtain catch·pot⁻¹·day⁻¹ estimates for the standard and experimental pots. Several pots were lost or damaged, reducing the number of subsamples for that given sampling event. If a single pot of a pair was lost, then the corresponding pair was removed to ensure a balanced number of samples per pot type remained (out of a potential of 2360 samples, 96 samples were removed). During any given sampling date, there were never less than 8 subsamples per pot type and line, with the single exception of October 12 when only one line was fished.

The effect of pot type (standard, experimental cull panel), season (spring, summer, fall), and time of pot submersion (24, 48 hours) on the number, biomass and size of blue crabs caught was assessed with generalized linear models (SPSS17.0). Total, legal-size and sublegal-size crabs were examined separately. For all comparisons, a regression model using a normal distribution and identity link function was applied to untransformed data.

Results: Over the 59 days that were fished in the lower York River, a total of 13,711 crabs were captured in 234 samples (Table 1). In standard pot samples (n=117), 6553 total crabs were captured (5664 legal-size, 889 sublegal-size). In the experimental pot samples (n=117), 7158 total crabs were captured (6362 legal-size, 796 sublegal-size). The majority of the crabs captured were female (67%) for both standard and experimental pots (standard: 4355 female: 2167 male; experimental: 4752 female: 2386 male), with 51 crabs unidentified as either sex.

Abundance: Crab catches (crabs·pot−1·day−1±SE) were similar between standard and experimental pots for legal-size crabs (standard: 5.0±0.3; exp: 5.6±0.3). Sublegal-size crab catch was lower in experimental pots than standard pots (standard: 1.5±0.04; exp: 1.4±0.04). A higher mean catch of legal-size crabs was observed in summer (6.1±0.3) as compared to spring and fall (4.9±0.3, 4.9±0.4, respectively). Sublegal crab catch was similar among seasons (−1.5±0.5). When pots were submerged for 48 hours, the number of legal-size crabs increased from 5.4 to 6.2 (±0.3) crabs·pot⁻¹·day⁻¹. Sublegal-size crab catch was similar between pot submersion time periods (1.5±0.04 crabs·pot⁻¹·day⁻¹).

Biomass: Estimated mean biomass (grams·pot⁻¹·day⁻¹±SE) was similar between standard and experimental pots for legal (122.9, 124.5±0.9) and sublegal-size (80.5±0.9, 78.3±0.8) crabs. Legal crabs had lower biomass in fall catches (120.1±1.4) than spring and summer (126.8, 124.1±1.0) and sublegal-size crab biomass was similar among seasons. The mean biomass for sublegal-size crabs was higher in pots submerged for 48 hours relative to 24 hours (81.4±0.8, 77.3±1.0), but similar for legal-size crabs.

Size: The mean size of legal-size crabs was slightly larger in experimental (14.0±0.04 cm) than standard (13.9±0.04 cm) pots. Sublegal crab sizes were similar between pot types (Table 2; FIG. 3). Legal-size crabs were on average 2.0 to 3.0 mm larger in carapace width in the spring than in summer and fall, and sublegal-size crabs were similar sizes among seasons. On average, sublegal crabs were 3.0 mm larger in carapace width in pots submerged for 48 as opposed to 24 hours.

Example 3. Oval biodegradable cull ring panels were produced from either PCL or PHA. The length of the panel was 150 mm, the width was 100 mm at the widest point, and the thickness was 1.5 mm. Each panel included a cull ring of 60 mm (2⅜ in) inside diameter (to correspond to the regulation cull ring size used in standard pots). An oval section of crab pot wire of the same size was removed from opposite sides of the upper chamber of the crab pot and the panels attached using polyamide (nylon) cable ties (FIG. 1). Cull ring position was kept consistent for standard and experimental pots. During the spring (April/May), summer (July/August) and fall (October/November), a line of 10 crab pots were fished by licensed watermen in 5 locations of the Lower Chesapeake Bay. Pots were fished at 1) Eastern Shore (Lower Bay), 2) York River, 3) James River, 4) Wicomico (Western shore of upper Bay near Great Wicomico River), and 5) Tangier Island. Each line consisted of 5 pairs of pots. The standard (control) crab pots had 2 cull rings and the experimental crab pots had 2 biodegradable cull panels, made from either PCL or PHA. Pairs of pots were placed next to each other along the line (i.e. standard, experimental, standard, experimental). Each line of pots was considered an experimental unit and the individual pots were considered subsamples.

Pots were fished in conjunction with commercial fishing for five consecutive days each season. Experimental and standard pots were similarly baited with seasonally available bait. The numbers and sizes of crabs were recorded for each trap and fishing period. A crab was designated as legal-size if it exceeded 12.5 cm. Fish bycatch were noted. Biomass was estimated from carapace width (CW) using the equations described in Example 2 above.

For each pot and sampling event, the number and biomass of crabs were summed and the mean catch size estimated. Within a given line (experimental unit), catch information was then averaged across subsamples for each sample date and pot type to obtain catch per pot per day estimates for the standard and experimental pots. The effect of pot type (standard, experimental cull panel), season (spring, summer, fall), and location (Eastern Shore, York River, James River, Wicomico, Tangier) on the number, biomass and size of blue crabs caught was assessed with generalized linear models (GLZ). Total, legal-size and sublegal-size crabs were examined separately. For all comparisons, a regression model using a normal distribution and log link function was applied to data.

Results: Over the 77 days that were fished in the five regions described above, a total of 8,486 crabs were captured in 1524 samples. While each waterman was anticipated to fish for 15 total days, one fished for 14 days (York River) and another fished for 18 days (James River). In the standard pot samples (n=762), 4369 total crabs were captured (3958 legal-size, 411 sublegal-size). In the experimental pot samples (n=762), 4117 total crabs were captured (3663 legal-size, 454 sublegal-size). The majority of the crabs captured were female (73%) for both standard and experimental pots (standard: 3192 female: 1135 male; experimental: 2984 female: 1090 male) with 42 crabs unidentified as either sex. Season, location and the interaction of season with location were significantly related to abundance, biomass and size measures for both legal and sublegal-size crabs.

Abundance: Crab catches (crabs·pot⁻¹·day⁻¹±SE) were similar between standard and experimental pots for both legal-size (standard: 9.3±0.3; exp: 8.7±0.3) and sublegal-size crabs (standard: 1.6±0.1; exp: 1.7±0.1). On average, approximately four more crabs·pot⁻¹·day⁻¹ were captured in the summer than spring and fall. Legal-size catches from the Eastern Shore (16.6±0.5) were higher than other locations (range 6.5-9.8). Catches of sublegal-size crabs were higher in the Eastern Shore (1.8±0.1) and York River (2.0±0.1) locations than other areas (range: 1.4-1.6±0.1).

Biomass: Estimated mean biomass (grams·pot⁻¹·day⁻¹±SE) was similar between standard and experimental pots for legal-size crabs (standard: 141.4±0.9; exp: 140.6±0.9). Sublegal-size crabs weighed more in experimental pots (standard: 76.2±0.8; exp: 78.5±0.8). Legal-size crabs were on average heavier in the fall (147.3) than in the spring (140.8) and summer (135.2). Sublegal-size crabs were heavier in the summer and fall (79.2, 82.5) than in the spring (71.7).

Size: The mean size of legal (14.6 cm) and sublegal (−11.6 cm) crabs was similar in standard and experimental pots. In the spring and fall, legal-size crabs were on average 3-4 mm larger and sublegal-size crabs were 3-4 mm smaller than in summer months. Catches varied among the six individual commercial watermen due to fishing locations and possibly techniques. For instance, the York River was fished by separate individuals, and mean catch varied by nearly a factor of two. However, paired standard and experimental pots for each waterman had similar catch. This suggests that regardless of location and user, modified pots are capturing blue crabs as effectively as standard pots.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e. to at least one) of the grammatical object of the article. By way of example, “a trap” means one trap or more than one trap.

Any ranges cited herein are inclusive.

We claim:

1. A method for reducing ghost fishing in abandoned crustacean traps comprising:
attaching a degradable cull panel to a crustacean fishing trap; and
fishing for crustaceans of one or more targeted crustacean species using said trap;
wherein said degradable cull panel comprises a polyhydroxyalkanoate material;
wherein said degradable cull panel comprises a physical barrier sufficient to prevent escape of adult crustaceans prior to degradation of said degradable cull panel;
wherein said degradable cull panel degrades more slowly when actively fished in a marine environment than when continuously soaked in a marine environment; and
wherein said degradable cull panel degrades sufficiently within about eight months of said panel being continuously submerged in a marine environment such that mature crustaceans of a targeted crustacean species can escape from said trap.

2. The method of claim 1, wherein said degradable cull panel comprises, prior to any degradation, at least one escape ring through which sublegal sized crustaceans can escape.

3. The method of claim 1, wherein said polyhydroxyalkanoate material has a tensile strength of at least 23 mPa when subjected to ASTM method D638, and wherein said polyhydroxyalkanoate material has a tensile elongation at break of at least 6% when subjected to ASTM method D638.

4. The method of claim 1, wherein said degradable cull panel loses less than 20% of its weight when actively fished for six months in a marine environment; and wherein said degradable cull ring panel loses more than 20% of its weight when continuously soaked for six months in a marine environment.

5. The method of claim 1, wherein said degradable cull panel loses less than 20% of its weight when actively fished for eight months in a marine environment; and wherein said degradable cull ring panel loses more than 40% of its weight when continuously soaked for eight months in a marine environment.

6. The method of claim 1, wherein the trap is rendered ineffective to capture marine life within about eight months of said trap being continuously submerged in a marine environment.

7. The method of claim 1, wherein said marine environment is selected from the group consisting of the Atlantic Ocean and the Chesapeake Bay.

8. The method of claim 1, wherein said degradable cull panel comprises an area of greater than 15 square inches but less than 30 square inches.

9. The method of claim 1, wherein said crustacean trap is a lobster trap.

10. The method of claim 1, wherein said crustacean trap is a crab trap.

11. The method of claim 1, wherein said targeted crustacean species is Callinectes sapidus.

12. A degradable cull panel adapted for attachment to a crustacean fishing trap comprising:
a polyhydroxyalkanoate material;
at least one escape ring through which sublegal sized crustaceans can swim and therefore escape from a crustacean fishing trap to which said degradable cull panel is attached; and
a physical barrier sufficient to prevent escape of mature crustaceans prior to degradation of said degradable cull panel;
wherein said polyhydroxyalkanoate material has a tensile strength of at least 23 mPa when subjected to ASTM method D638; and
wherein said degradable cull panel degrades sufficiently within about eight months of said panel being continuously submerged in a marine environment that mature crustaceans of a crustacean species targeted by said crustacean fishing trap can escape from said crustacean fishing trap through an opening created by the degradation of said degradable cull panel.

13. The degradable cull panel of claim 12, wherein said degradable cull panel degrades more slowly when actively fished in a marine environment than when continuously soaked in a marine environment.

14. The degradable cull panel of claim 12, wherein said degradable cull panel loses less than 20% of its weight when actively fished for six months in a marine environment; and wherein said degradable cull ring panel loses more than 20% of its weight when continuously soaked for six months in a marine environment.

15. The degradable cull panel of claim 12, wherein said degradable cull panel loses less than 20% of its weight when actively fished for eight months in a marine environment; and wherein said degradable cull ring panel loses more than 40% of its weight when continuously soaked for eight months in a marine environment.

16. The degradable cull panel of claim 12, wherein said degradable cull panel comprises an area of greater than 15 square inches but less than 30 square inches.

17. The degradable cull panel of claim 12, wherein said degradable cull panel is adapted for attachment to a crab fishing trap.

18. The degradable cull panel of claim 12, wherein said degradable cull panel is adapted for attachment to a lobster fishing trap.
